(19) United States
(12) Patent Application Publication
(10) Pub. No.: US 2025/0088691 A1
(43) Pub. Date: Mar. 13, 2025

(54) METHOD FOR DETERMINING LIVE STREAMING DELAY, TERMINAL DEVICE, AND STORAGE MEDIUM

(71) Applicant: Beijing Zitiao Network Technology Co., Ltd., Beijing (CN)

(72) Inventor: Donghui ZHANG, Beijing (CN)

(21) Appl. No.: 18/830,140

(22) Filed: Sep. 10, 2024

(30) Foreign Application Priority Data
Sep. 13, 2023 (CN) 202311183041.4

(51) Int. Cl. H04N 21/262; H04N 21/2187; H04N 21/442

(52) U.S. Cl. CPC H04N 21/2625; H04N 21/2187; H04N 21/44213

(57) ABSTRACT

The present disclosure provides a method and an apparatus for determining a live streaming delay, a terminal device, and a storage medium. The method includes: determining a user type corresponding to a user watching a live stream; acquiring a network parameter for the user when watching the live stream; determining, based on the user type and the network parameter, a delay parameter for the user when watching the live stream, in which the delay parameter is associated with a delay of the user watching the live stream; and sending the delay parameter to a multimedia server, and receiving live streaming data sent by the multimedia server based on the delay parameter.

### CROSS-REFERENCE TO RELATED APPLICATION

The present application claims the priority to Chinese Patent Application No. 202311183041.4, filed on Sep. 13, 2023, the entire disclosure of which is incorporated herein by reference as portion of the present application.

### TECHNICAL FIELD

Embodiments of the present disclosure relate to a method and an apparatus for determining a live streaming delay, a terminal device, and a storage medium.

### BACKGROUND

In a live streaming scenario, the end-to-end delay is important to the experience of a user watching the live stream, the less the end-to-end delay, the better the user's interaction effect.

Currently, the server may set the delay parameter for a live stream to a fixed parameter so that the live streaming delay is the same for each client playing the live stream. For example, the server may set the live streaming delay to 10 seconds, so that there is a 10 second delay for each user watching the live stream, and the live stuttering problem may be avoided. However, this results in less flexibility in setting the live streaming delay.

### SUMMARY

The present disclosure provides a method and an apparatus for determining a live streaming delay, a terminal device, and a storage medium.

In a first aspect, the present disclosure provides a method for determining a live streaming delay, and the method includes:
determining a user type corresponding to a user watching a live stream;
acquiring a network parameter for the user when watching the live stream;
determining, based on the user type and the network parameter, a delay parameter for the user when watching the live stream, wherein the delay parameter is associated with a delay of the user watching the live stream; and
sending the delay parameter to a multimedia server, and receiving live streaming data sent by the multimedia server based on the delay parameter.

In a second aspect, the present disclosure provides an apparatus for determining a live streaming delay, and the apparatus includes a first determination module, an acquisition module, a second determination module, a sending module and a receiving module;
the first determination module is configured to determine a user type corresponding to a user watching a live stream;
the acquisition module is configured to acquire a network parameter for the user when watching the live stream;
the second determination module is configured to determine, based on the user type and the network parameter, a delay parameter for the user when watching the live stream, in which the delay parameter is associated with a delay of the user watching the live stream;
the sending module is configured to send the delay parameter to a multimedia server; and
the receiving module is configured to receive live streaming data sent by the multimedia server based on the delay parameter.

In a third aspect, the present disclosure provides a terminal device including a processor and a memory;
the memory is configured to store computer-executable instructions; and
the processor is configured to execute the computer-executable instructions stored in the memory to implement the method for determining a live streaming delay according to the first aspect or any embodiment in the first aspect.

In a fourth aspect, the present disclosure provides a non-transitory computer-readable storage medium, which stores computer-executable instructions; and a processor, when executing the computer-executable instructions, implements the method for determining a live streaming delay according to the first aspect or any embodiment in the first aspect.

The present disclosure provides a method and an apparatus for determining a live streaming delay, a terminal device, and a storage medium, and the method includes: determining a user type corresponding to a user watching a live stream; acquiring a network parameter for the user when watching the live stream; determining, based on the user type and the network parameter, a delay parameter for the user when watching the live stream, in which the delay parameter is associated with a delay of the user watching the live stream; and sending the delay parameter to a multimedia server, and receiving live streaming data sent by the multimedia server based on the delay parameter. In the above-mentioned method, because the terminal device can determine the delay parameter for the user when watching the live stream in combination with the user type and the current network parameter, the terminal device can flexibly set the delay for each user when watching the live stream, thereby improving the flexibility of determining the live streaming delay, and saving the network bandwidth and improving the user experience.

### BRIEF DESCRIPTION OF DRAWINGS

In order to more clearly illustrate the technical solutions of the embodiments of the present disclosure, the drawings that need to be used in description of the embodiments will be briefly described in the following. Apparently, the drawings in the following description are only some embodiments of the present disclosure. For those skilled in the art, other drawings can also be obtained based on these drawings without any inventive work.

FIG. 1 is a schematic diagram of an application scenario provided by the embodiments of the present disclosure;

FIG. 2 is a schematic flowchart of a method for determining a live streaming delay provided by the embodiments of the present disclosure;

FIG. 3 is a schematic diagram of a process of determining a delay parameter provided by the embodiments of the present disclosure;

FIG. 4 is another schematic diagram of a process of determining a delay parameter provided by the embodiments of the present disclosure;

FIG. 5 is a schematic diagram of a process of sending a delay parameter provided by the embodiments of the present disclosure;

FIG. 6 is a schematic diagram of a method for determining a user type provided by the embodiments of the present disclosure;

FIG. 7 is a schematic diagram of a determination process of a live streaming delay provided by the embodiments of the present disclosure;

FIG. 8 is a schematic structural diagram of an apparatus for determining a live streaming delay provided by the embodiments of the present disclosure; and

FIG. 9 is a schematic structural diagram of a terminal device provided by the embodiments of the present disclosure.

### DETAILED DESCRIPTION

Exemplary embodiments will be described in detail here, and the exemplary embodiments are shown in the drawings. In the case where the following description refers to the drawings, same numbers in different drawings represent the same or similar elements unless otherwise indicated. The implementations described in the following exemplary embodiments do not represent all implementations consistent with the present disclosure. Rather, they are merely examples of apparatuses and methods consistent with some aspects of the present disclosure, as detailed in the appended claims.

For ease of understanding, concepts involved in the embodiments of the present disclosure are explained below.

A terminal device is a device having wireless receiving and sending functions. The terminal device may be deployed on land, e.g., in a room or outdoors, held in hand, worn, or on a vehicle. The terminal device may be a mobile phone, a Pad, a computer with wireless receiving and sending functions, a virtual reality (VR) terminal device, an augmented reality (AR) terminal device, a wireless terminal in industrial control, an vehicle-mounted terminal device, a wireless terminal in self driving, a wireless terminal device in remote medical, a wireless terminal device in smart grid, a wireless terminal device in transportation safety, a wireless terminal device in smart city, a wireless terminal device in smart home, a wearable terminal device, or the like. The terminal device involved in the embodiments of the present disclosure may also be referred to as a terminal, user equipment (UE), an access terminal device, a vehicle-mounted terminal, an industrial control terminal, a UE unit, a UE station, a mobile station, a mobile platform, a distant station, a remote terminal device, a mobile device, a UE terminal device, a wireless communication device, a UE agent, a UE apparatus, or the like. The terminal device may be stationary or mobile.

In the related art, the end-to-end delay is important to the experience of a user watching a live stream. For example, if the end-to-end delay is less, the user watching the live stream can interact with the live streamer in a timely manner, thereby improving the effectiveness of the live stream. Currently, the server may set the delay parameter for a live stream to a fixed parameter so that the live streaming delay is the same for each client playing the live stream. For example, the server may set the live streaming delay to 10 seconds, so that each user has the same progress in watching the live stream, and for users with poor network conditions, the live streaming delay will not cause the live stream to stutter. However, each user has different habits in watching live stream, and each user has different network conditions when watching live stream. Fixed delay parameters will result in low flexibility in setting the live streaming delay, and will waste network bandwidth for users with better network conditions.

In order to solve the technical problem in the related art, the embodiments of the present disclosure provide a method for determining a live streaming delay, which includes: determining a user type corresponding to a user watching a live stream; acquiring a network parameter for the user when watching the live stream; determining, based on the network parameter, a network quality level for the user when watching the live stream; in response to the network quality level being greater than or equal to the first threshold, and the user type including a non-stuttering type, setting the delay parameter to a first preset value; in response to the network parameter being less than the first threshold, or the user type including a stuttering type, further determining, based on the user type, the delay parameter for the user when watching the live stream; and sending the delay parameter to a multimedia server, and receiving live streaming data sent by the multimedia server based on the delay parameter. Thus, because the terminal device can flexibly determine the delay parameter when watching a live stream based on the user type and the network parameter, the flexibility of setting the delay parameter of the live stream can be improved, and the low delay can effectively save the network bandwidth for the user whose network is better.

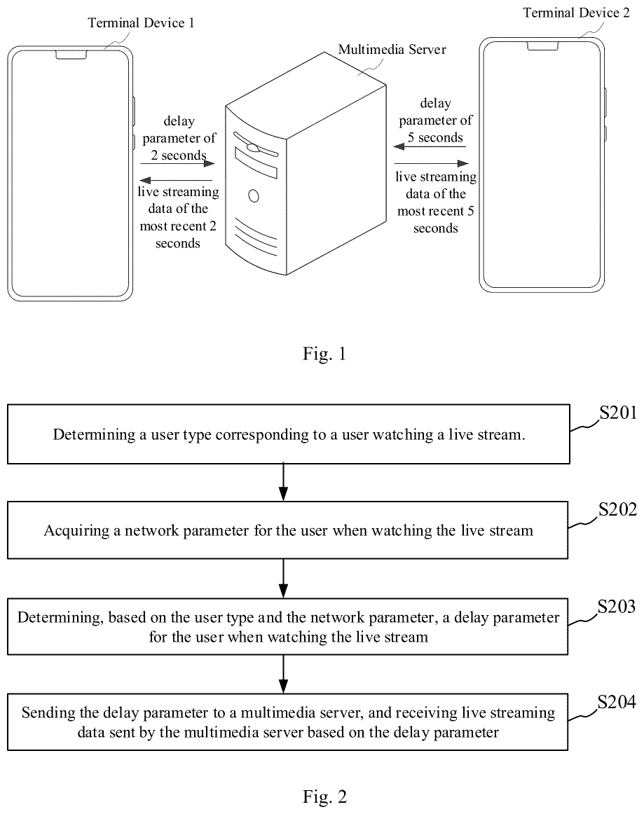

Next, the application scenario of the embodiments of the present disclosure will be explained in conjunction with FIG. 1.

FIG. 1 is a schematic diagram of an application scenario provided by the embodiments of the present disclosure. Please refer to FIG. 1, a terminal device 1, a terminal device 2, and a multimedia server are included. The multimedia server may send live streaming data to the terminal device 1 and the terminal device 2, the terminal device 1 and the terminal device 2 may play a live streaming video, the account to which the live streaming client of the terminal device 1 is logged in is an account of the user 1, and the account to which the live streaming client of the terminal device 2 is logged in is an account of the user 2.

Please refer to FIG. 1, the terminal device 1 may determine, based on the user type of the user 1 and the current network parameter of the terminal device 1, that the delay parameter of watching live stream by the user 1 is 2 seconds, the delay parameter of 2 seconds is sent to the multimedia server, and the multimedia server may send live streaming data of the most recent 2 seconds to the terminal device 1. The terminal device 2 may determine, based on the user type of the user 2 and the current network parameter of the terminal device 2, that the delay parameter of watching live stream by the user 2 is 5 seconds, the delay parameter of 5 seconds is sent to the multimedia server, and the multimedia server may send live streaming data of the most recent 5 seconds to the terminal device 2. Thus, the terminal device can flexibly adjust the delay parameter of the current live stream based on the user type and the network parameter, thereby improving the flexibility of setting the delay parameter, and saving the network bandwidth.

It should be noted that FIG. 1 is only an illustrative example of an application scenario of the embodiments of the present disclosure, and is not intended to limit the application scenario of the embodiments of the present disclosure.

The technical solutions of the present disclosure and how the technical solutions of the present disclosure solve the above technical problems are explained in detail below in specific embodiments. The following several specific embodiments may be combined with each other, and the same or similar concepts or processes may not be repeated in some embodiments. The embodiments of the present disclosure will be described below with reference to the drawings.

FIG. 2 is a schematic flowchart of a method for determining a live streaming delay provided by the embodiments of the present disclosure. Please refer to FIG. 2, the method may include the following steps.

S201, determining a user type corresponding to a user watching a live stream.

The execution subject of the embodiment of the present disclosure may be a terminal device, and may also be an apparatus for determining a live streaming delay set in a terminal device. For example, the apparatus for determining a live streaming delay may be implemented based on software, and may also be implemented based on a combination of software and hardware, which is not limited by the embodiments of the present disclosure.

The user watching the live stream may be a user who logs into the live streaming client. For example, if the user who logs in the live streaming client in the terminal device is user 1, the user watching the live stream may be user 1; and if the user who logs in the live streaming client in the terminal device is user 2, the user watching the live stream may be user 2.

It should be noted that the terminal device may determine the user watching the live stream based on any feasible implementation, and the embodiments of the present disclosure do not limit this.

For example, the user type may include a stuttering type or a non-stuttering type, and the user type may further include an interactive type or a non-interactive type. For example, the user types corresponding to the user watching the live stream may include a stuttering and interactive type, a stuttering and non-interactive type, a non-stuttering and interactive type, and a non-stuttering and non-interactive type.

A stuttering type user may refer to a user who watches a live stream at a higher stuttering frequency during a historical period. For example, if a user watches live stream every day for the past 7 days, where live stream stuttering occurred for 4 days, the user type corresponding to the user may be the stuttering type. For example, if a user watches live stream stuttered 20 times in the past 7 days, the user type corresponding to the user may be the stuttering type.

The non-stuttering type user may refer to a user who watches a live stream at a lower stuttering frequency during a historical period. For example, if a user watches live stream every day for the past 7 days, and a live stream stuttering has not occurred every day, the user type corresponding to the user may be the non-stuttering type. For example, if a user watches live stream stuttered one time in the past 7 days, the user type corresponding to the user may be the non-stuttering type.

The interactive type user may refer to a user who interacts with the live streamer a higher number of times when watching the live stream. For example, if a user watches a live stream with 100 likes of the live stream, the user type corresponding to the user may be the interactive type. For example, if a user sends 100 comments when watching a live stream, the user type corresponding to the user may be the interactive type.

The non-interactive type user may refer to a user who interacts with the live streamer a lower number of times when watching the live stream. For example, if a user watches a live stream and likes the live stream 0 times, the user type corresponding to the user may be the non-interactive type. For example, if a user sends 1 comment when watching a live stream, the user type corresponding to the user may be the non-interactive type. In this way, by classifying the user, the habit of the user when watching the live stream may be accurately determined, and furthermore, the delay for the user when watching the live stream may be accurately set, thereby improving the accuracy of determining the delay, and improving the user experience.

S202, acquiring a network parameter for the user when watching the live stream.

Optionally, the network parameter may indicate the network state for the user when watching the live stream. For example, the network parameter may include a network bandwidth, the greater the network bandwidth, the better the network state for the user when watching the live stream, and the less the network bandwidth, the worse the network state for the user when watching the live stream. For example, the network parameter may include round-trip time (RTT), the less the RTT, the better the network state for the user when watching the live stream, and the greater the RTT, the worse the network state for the user when watching the live stream.

It should be noted that the network parameter may include the network bandwidth and RTT, and that the network parameter may include any parameter that affect the network state, and the embodiments of the present disclosure are not limited in this regard.

It should be noted that the terminal device may acquire the network parameter for the user when watching the live stream based on any feasible implementation, which is not limited by the embodiments of the present disclosure.

S203, determining, based on the user type and the network parameter, a delay parameter for the user when watching the live stream.

The delay parameter is associated with a delay of the user watching the live stream. For example, the delay parameter may determine the delay of the user watching the live stream. For example, in response to the delay parameter being Parameter 1, the delay for the user when watching the live stream is Delay 1; in response to the delay parameter being Parameter 2, the delay for the user when watching the live stream is Delay 2; and in response to the delay parameter being Parameter 3, the delay for the user when watching the live stream is Delay 3.

For example, the correspondence between the delay parameter and the delay is a preset relationship, and the terminal device can pre-agree on the correspondence with the server, so that the terminal device can control the delay of the live stream through the delay parameter.

For example, the terminal device may determine the delay parameter for the user when watching the live stream based on the following feasible implementation: determining, based on the network parameter, a network quality level for the user when watching the live stream; and determining, based on the network quality level and the user type, the delay parameter for the user when watching the live stream.

The network quality level is directly proportional to the network state for the user when watching the live stream. For example, the network quality level may include Level 1, Level 2, Level 3, Level 4, and the like. For example, the higher the network quality level, the better the network state for the user when watching the live stream; and the lower the network quality level, the worse the network state for the user when watching the live stream. For example, if the network quality level when the user 1 watches the live stream is 2 and the network quality level when the user 2 watches the live stream is 4, it indicates that the network state when the user 2 watches the live stream is better than the network state when the user 1 watches the live stream. In this way, the network state in which the user watches the live stream can be accurately and visually determined based on the network quality level, thereby improving the accuracy of determining the delay parameter.

Optionally, the terminal device may estimate the current network quality by acquiring network parameters such as playback download speed, stuttering information, RTT information within a time window using a time sliding window method. For example, the acquisition time window may be set to 10 seconds, the acquisition time window may be any length of time, and the embodiments of the present disclosure are not limited in this regard; the smaller the acquisition time window, the greater the impact on the network quality of the network parameters of the most recent time period; and the larger the acquisition time window, the less the impact on the network quality of the network parameters of the most recent time period.

Optionally, the terminal device may determine the network quality level based on the network bandwidth and RTT among the network parameters. For example, if the network bandwidth is greater than 3000 kb/s, the RTT is less than 23 ms, the network quality level is level 4; if the network bandwidth is greater than 2338 kb/s and less than or equal to 3000 kb/s, and the RTT is greater than or equal to 23 ms and less than 46 ms, the network quality level is level 3; if the network bandwidth is greater than 816 kb/s and less than or equal to 2338 kb/s, and the RTT is greater than or equal to 46 ms and less than 77 ms, the network quality level is level 2; and if the network bandwidth is less than or equal to 816 kb/s and the RTT is greater than or equal to 77 ms, the network quality level is level 1.

It should be noted that if the network bandwidth is greater than 3000 kb/s, but the RTT is greater than or equal to 23 ms and less than 46 ms, the terminal device determines that the network quality level is level 3 (i.e., backward compatible).

For example, the terminal device determines the delay parameter for the user when watching the live stream based on the network quality level and the user type. There are two cases as follows.

Case 1: the network quality level is greater than or equal to a first threshold, and the user type includes a non-stuttering type.

The delay parameter is set to a first preset value in response to the network quality level being greater than or equal to the first threshold and the user type including the non-stuttering type. For example, if the network quality level includes level 1, level 2, level 3, and level 4, the first threshold may be 4, that is, in response to the network quality level being level 4, and the user type including the non-stuttering type, the terminal device may set the delay parameter of the user to the first preset value.

It should be noted that the first threshold may also be determined based on any one of the network quality levels, and the embodiments of the present disclosure are not limited in this respect.

Optionally, the first preset value may be the value of the delay parameter corresponding to the lowest delay. For example, if the network quality level is greater than or equal to the first threshold, it indicates that the user has a better network state when watching the live stream, and if the user type includes the non-stuttering type, it indicates that the user has less stuttering when watching the live stream during the historical time period. Therefore, the terminal device can provide less delay for such users to improve user experience and save network bandwidth. For example, the Flash Video (FLV) delay based on the streaming media encapsulation protocol may be 2 seconds at a minimum, and thus, the first preset value may be a delay parameter corresponding to the delay of 2 seconds.

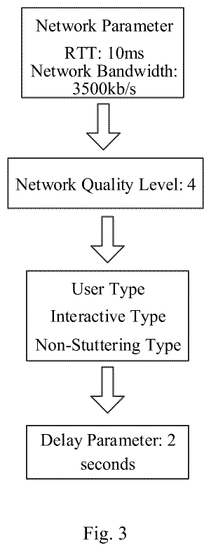

Next, the process of determining the delay parameter in this case will be described with reference to FIG. 3.

FIG. 3 is a schematic diagram of a process of determining a delay parameter provided by the embodiments of the present disclosure. Please refer to FIG. 3, the network parameter and the user type are included. The network parameter includes RTT and network bandwidth, RTT is 10 ms and network bandwidth is 3500 kb/s, and the user type includes interactive type and non-stuttering type. The terminal device determines that the network quality level of the terminal device is level 4 based on the RTT and the network bandwidth among the network parameters, and because the user type includes the non-stuttering type, the terminal device may determine that the delay parameter for the user when watching the live stream is 2 seconds (the delay parameter corresponding to the delay of 2 seconds). Thus, if the user's network quality is high and the user's habit of watching live stream is less stuttering, the terminal device can request to acquire less live streaming delay, thereby improving the flexibility of setting the live streaming delay, and improving the user experience.

Case 2: the network quality level is less than the first threshold, or the user type includes the stuttering type.

In response to the network quality level being less than the first threshold, or the user type including the stuttering type, the delay parameter is determined for the user when watching the live stream according to the user type. For example, in response to the network quality level of the terminal device being less than the first threshold, it indicates that the network state of the user watching the live stream is poor, and therefore, the terminal device can further determine the delay parameter of the user watching the live stream according to the user type. For example, in response to the user type corresponding to the user watching the live stream including the stuttering type, it indicates that stuttering occurs at a high frequency for the user when watching the live stream (a high stuttering frequency due to a poor network, or a high stuttering frequency due to a habit of the user watching the live stream, such as watching the live stream with a high definition, etc.), and therefore, the terminal device may further determine the delay parameter for the user when watching the live stream based on the user type.

For example, determining, based on the user type, the delay parameter for the user when watching the live stream may include: in response to the user type further including an interactive type, setting the delay parameter to a second preset value; and in response to the user type further including a non-interactive type, setting the delay parameter to a third preset value.

The first preset value is less than the second preset value, and the second preset value is less than the third preset value. For example, the first preset value may correspond to a live streaming delay of 2 seconds, the second preset value may correspond to a live streaming delay of 3 seconds, and the third preset value may correspond to a live streaming delay of 5 seconds, which are not limited in the embodiments of the present disclosure.

Optionally, in response to the network quality level being low or the user type including the stuttering type, the terminal device may further determine the user's habit of watching the live stream based on the user type, and may accurately determine the delay parameter for the user when watching the live stream based on the user's habit of watching the live stream, thereby improving the flexibility and accuracy of setting the delay parameter, and improving the user experience.

For example, if the user type further includes the interactive type, it indicates that the user interacts with the live streamer at a higher frequency when watching the live stream. Therefore, in order to improve the interactive experience of the live stream, the terminal device may request a less live streaming delay. In addition, because the network is poor or the user watches live stream stuttering at a higher frequency, the live streaming delay may be set to a moderate value (e.g., if the least delay is 2 seconds, the live streaming delay may be 3 seconds, 4 seconds, etc.) in order to avoid stuttering frequently (the less the delay, the higher the stuttering frequency), which may not only avoid stuttering frequently, but also improve the interactive effect of live stream and improve the user experience.

For example, if the user type further includes the non-interactive type, it indicates that the user interacts with the live streamer at a lower frequency when watching the live stream. Therefore, the terminal device may request a greater live streaming delay (e.g., if the minimum delay is 2 seconds, the live streaming delay may be 5 seconds, 6 seconds, etc.), thereby avoiding a stuttering of the live stream due to a poor network or the user's habits of watching the live stream, thereby improving the user experience.

It should be noted that in the embodiments of the present disclosure, the first preset value, the second preset value and the third preset value may be arbitrarily set, but, the first preset value is less than the second preset value, and the second preset value is less than the third preset value, so that the terminal device can flexibly set the matching delay parameter for the user in combination with the network state and the user's habit of watching live stream, thereby improving the user experience. For example, if the network quality level of the terminal device is level 4 and the user type corresponding to the user watching the live stream includes the non-stuttering type, the network state of the user watching the live stream is good and the frequency of stuttering occurring in historical watching of the live stream is low, so that the terminal device can request a delay of 2 seconds for the user. If the network quality level of the terminal device is level 2, the terminal device may further determine the user's habit of watching live stream. If the user type includes the interactive type, it indicates that the user is habit to interact with the live streamer. Therefore, the terminal device may request a delay of 3 seconds for the user. If the user type includes the non-interactive type, it indicates that the user is not habit to interact with the live streamer, and to avoid stuttering, the terminal device may request a delay of 5 seconds for the user. In this way, the flexibility of setting the live streaming delay may be improved, the accuracy of setting the live streaming delay may be improved, and the network bandwidth may be saved.

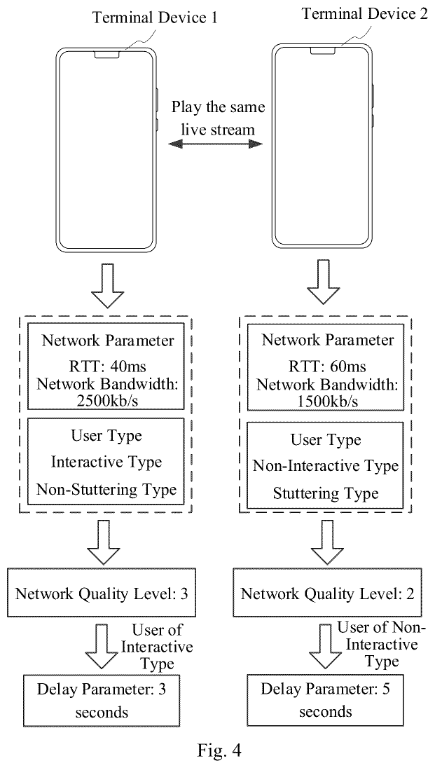

The process of determining the delay parameter in this case will be described below with reference to FIG. 4.

FIG. 4 is a schematic diagram of a process of determining a delay parameter provided by the embodiments of the present disclosure. Please refer to FIG. 4, a terminal device 1 and a terminal device 2 are included, and the terminal device 1 and the terminal device 2 play the same live stream. The network parameters of the terminal device 1 are: RTT of 40 ms and network bandwidth of 2500 kb/s, and the network parameters of the terminal device 2 are: RTT of 60 ms and network bandwidth of 1500 kb/s. The user types corresponding to the users who log in the live streaming client in the terminal device 1 include the interactive type and the non-stuttering type, and the user types corresponding to the users who log in the live streaming client in the terminal device 2 include the non-interactive type and the stuttering type.

Referring to FIG. 4, the network quality level corresponding to the network parameter of the terminal device 1 is level 3 (the network quality of the terminal device 1 is lower), because the user type corresponding to the user who logs in the live streaming client in the terminal device 1 includes the interactive type, the delay parameter requested by the terminal device 1 may be 3 seconds (i.e., the delay parameter corresponding to the live streaming delay of 3 seconds) in order to improve the interactive experience of the live stream. The network quality level corresponding to the network parameter of the terminal device 2 is level 2 (the network quality of the terminal device 2 is lower than the network quality of the terminal device 1), because the user type corresponding to the user who logs in the live streaming client in the terminal device 2 includes the non-interactive type, the delay parameter requested by the terminal device 2 may be 5 seconds (i.e., the delay parameter corresponding to the live streaming delay of 5 seconds) in order to avoid the case of stuttering, and thus, when the network is poor, the terminal device may also set the corresponding delay parameter for each user based on the user's habit of watching live stream, thereby improving the flexibility and accuracy of setting the delay parameter.

S204, sending the delay parameter to a multimedia server, and receiving live streaming data sent by the multimedia server based on the delay parameter.

Optionally, the multimedia server may be a Content Delivery Network (CDN), the terminal device may agree on a delay parameter to control the live streaming delay with the CND edge node, and the terminal device may send the delay parameter to the CND edge node based on an http request by a manner of http requesting query parameter.

For example, the terminal device sends the delay parameter to the multimedia server, specifically may be: adding the delay parameter in the playing request of the live stream, and sending the playing request after adding the delay parameter to the multimedia server. For example, when the terminal device plays any one live stream, the terminal device may add a delay parameter in a playing request of the live stream, and when the terminal device sends the playing request to the multimedia server, the multimedia server may acquire the delay parameter.

It should be noted that, the terminal device may determine the delay parameter when opening the live streaming client, and when the terminal device requests to play the live streaming video, the terminal device may add the delay parameter in the playing request corresponding to this live streaming video.

Optionally, after the terminal device sends the delay parameter to the multimedia server, the terminal device may receive the live streaming data sent by the multimedia server, and the live streaming data is generated based on the delay parameter. For example, the live streaming data may be cached in the CDN edge node, which may determine the live streaming data to send to the terminal device based on the delay parameter. For example, if the CDN edge node caches 5 seconds of live streaming data, and the delay parameter received by the CDN edge node is 2 seconds, the CDN edge node may send the last 2 seconds of live streaming data to the terminal device.

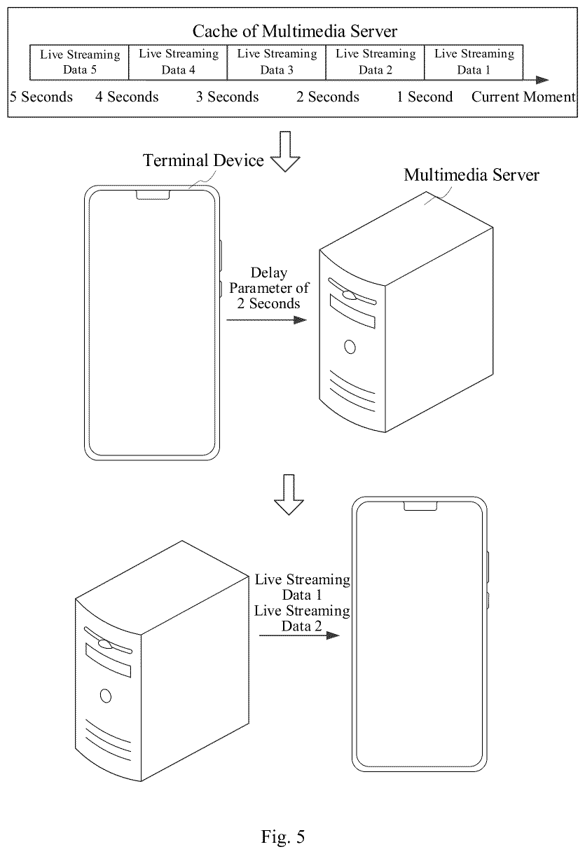

Next, a process in which the terminal device sends the delay parameter to the multimedia server will be described in conjunction with FIG. 5.

FIG. 5 is a schematic diagram of a process of sending a delay parameter provided by the embodiments of the present disclosure. Please refer to FIG. 5, a multimedia server, a terminal device, and a cache of the multimedia server are included, and 5 seconds of live streaming data may be cached in the cache of the multimedia server. The live streaming data from the current moment to 1 second ago is live streaming data 1, the live streaming data from 1 second ago to 2 seconds ago is live streaming data 2, the live streaming data from 2 seconds ago to 3 seconds ago is live streaming data 3, the live streaming data from 3 seconds ago to 4 seconds ago is live streaming data 4, the live streaming data from 4 seconds ago to 5 seconds ago is live streaming data 5. If the terminal device sends a delay parameter of 2 seconds to the multimedia server, the multimedia server may send the live streaming data 1 and the live streaming data 2 to the terminal device based on the delay parameter of 2 seconds.

The embodiments of the present disclosure provide a method for determining a live streaming delay, which includes: determining a user type corresponding to a user watching a live stream; acquiring a network parameter for the user when watching the live stream; determining, based on the network parameter, a network quality level for the user when watching the live stream; in response to the network quality level being greater than or equal to the first threshold, and the user type including a non-stuttering type, setting the delay parameter to a first preset value; in response to the network parameter being less than the first threshold, or the user type including a stuttering type, further determining, based on the user type, the delay parameter for the user when watching the live stream; and after determining the delay parameter, the terminal device may send the delay parameter to a multimedia server, receive live streaming data sent by the multimedia server based on the delay parameter. Thus, because the terminal device can flexibly determine the delay parameter when watching a live stream based on the user type and the network parameter, and the terminal device can set the matched delay parameter for the user in conjunction with the user's habit of watching the live stream, the flexibility of setting the delay parameter of the live stream can be improved, and the user experience can be improved, and the low delay can effectively save the network bandwidth for the user whose network is better.

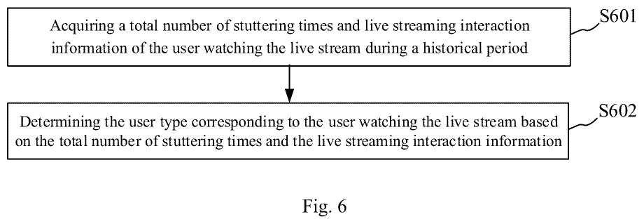

On the basis of the embodiment shown in FIG. 2, in conjunction with FIG. 6, a method of determining a user type corresponding to a user watching a live stream in the above-mentioned method for determining a live streaming delay will be described below.

FIG. 6 is a schematic diagram of a method for determining a user type provided by the embodiments of the present disclosure. Referring to FIG. 6, the method may include the following steps.

S601, acquiring a total number of stuttering times and live streaming interaction information of the user watching the live stream during a historical period.

Optionally, the stuttering may occur when the duration of the live video frame lag exceeds a preset threshold. For example, if the duration of the live video stopping playback is 2 seconds, the terminal device may determine that stuttering has occurred in the live stream. If the duration of the live video stopping playback is 0.1 seconds, the terminal device may determine that no stuttering has occurred in the live stream.

Optionally, the historical period may be within the past 7 days, within the past 15 days, etc., and the embodiments of the present disclosure are not limited thereto.

Optionally, the terminal device may acquire the number of stuttering times of the user watching the live stream in the historical period based on any feasible implementation (e.g., the terminal device acquires the number of stuttering times based on the multimedia server, the terminal device may also acquire the number of stuttering times in the live streaming log, etc.), which is not limited by the embodiments of the present disclosure.

Optionally, the live streaming interaction information may include any information that the user interacts with the live streamer. For example, the live streaming interaction information may include comments of the user on the live stream, likes of the user on the live stream, duration of the user watching the live stream, and the like, which are not limited in the embodiments of the present disclosure.

Optionally, the terminal device may acquire the live streaming interaction information based on any feasible implementation (e.g., the terminal device may acquire the live streaming interaction information of the user based on a multimedia server, etc.), which is not limited by the embodiments of the present disclosure.

S602, determining the user type corresponding to the user watching the live stream based on the total number of stuttering times and the live streaming interaction information.

For example, the terminal device determining the user type corresponding to the user watching the live stream based on the total number of stuttering times and the live streaming interaction information may include: determining the user type as a stuttering type or a non-stuttering type based on the total number of stuttering times; and determining the user type as an interactive type or a non-interactive type based on the live streaming interaction information.

Optionally, in response to the total number of stuttering times being greater than or equal to a second threshold, the terminal device may determine that the user type is the stuttering type; and in response to the total number of stuttering times being less than the second threshold, the terminal device may determine that the user type is the non-stuttering type. For example, in response to the total number of stuttering times of the user when watching the live stream in the past 7 days is 30, the terminal device may determine that the user type corresponding to the user is the stuttering type user; and in response to the total number of stuttering times of the user when watching the live stream in the past 7 days is 1, the terminal device may determine that the user type corresponding to the user is the non-stuttering type.

It should be noted that the second threshold may be determined based on any feasible implementation, and the embodiments of the present disclosure are not limited thereto.

For example, the terminal device determining the user type as the interactive type or the non-interactive type based on the live streaming interaction information may include: determining, based on the live streaming interaction information, an interaction frequency of the user when watching the live stream; in response to the interaction frequency being greater than or equal to a third threshold, determining the user type as the interactive type; and in response to the interaction frequency being less than the third threshold, determining the user type as the non-interactive type. For example, if the interaction frequency is greater than or equal to the third threshold, it indicates that the user has a high frequency of interaction with the live streamer when watching the live stream, and the terminal device may determine that the user type corresponding to the user is the interactive type; and if the interaction frequency is less than the third threshold, it indicates that the user has a low frequency of interaction with the live streamer when watching the live stream, and the terminal device may determine that the user type corresponding to the user is the non-interactive type.

Optionally, the terminal device may determine the number of interaction times for the user when watching the live stream based on the user's comments on the live stream, the user's likes on the live stream, and the like in the live streaming interaction information, and the terminal device may further determine the interaction frequency of the user when watching the live stream based on the duration of the user watching the live stream in the live streaming interaction information and the number of interaction times. For example, if the duration of the user watching the live stream in the past 7 days is 500 minutes, the number of likes of the user to watch the live stream is 10, and the number of comments of the user to watch the live stream is 40, the interaction frequency of the user watching the live stream in the past 7 days is 1 time for 10 minutes.

Optionally, the terminal device may further determine the user type corresponding to the user watching the live stream based on the multimedia server. For example, the multimedia server may acquire the number of stuttering times of a plurality of users when watching the live stream during a historical period, and thus may calculate whether each user is the stuttering type or the non-stuttering type; and the multimedia server may acquire the live streaming interaction information of the plurality of users when watching the live stream during the historical period, and thus, the multimedia server may determine whether each user is the interactive type or the non-interactive type, and thus, the multimedia server may store the user type corresponding to each user, and when the terminal device sends the user's identity to the multimedia server, the multimedia server may send the user type corresponding to the user to the terminal device.

Optionally, because the multimedia server can acquire the live streaming interaction information of a plurality of users, in determining whether each user is an interactive type user, the multimedia server may classify the plurality of users based on a clustering algorithm, in which one type is an interactive type and the other type is a non-interactive type. For example, the server may use a fixed step interval buckets to buckets likes and comments, and then select two adjacent buckets having the largest change in the number of people, and demarcate users of an interactive type from users of a non-interactive type, with respect to the center point of the bucket interval.

It should be noted that the multimedia server may determine whether the user type corresponding to the user is the interactive type based on any possible clustering algorithm, which is not limited by the embodiments of the present disclosure.

It should be noted that after the multimedia server determines the user type corresponding to each user, the multimedia server may further update the user type corresponding to the user in real time based on the number of stuttering times and the live streaming interaction information of the user watching the live stream.

The embodiments of the present disclosure provide a method for determining the live streaming delay, and the method includes: acquiring the total number of stuttering times and live streaming interaction information of the user watching the live stream during a historical period; in response to the total number of stuttering times being greater than or equal to the second threshold, determining the user type as the stuttering type by the terminal device; in response to the total number of stuttering times being less than the second threshold, determining the user type as the non-stuttering type by the terminal device; determining, based on the live streaming interaction information, the interaction frequency of the user when watching the live stream; in response to the interaction frequency being greater than or equal to the third threshold, determining the user type as the interactive type; and in response to the interaction frequency being less than the third threshold, determining the user type as the non-interactive type. In this way, the terminal device can accurately determine the user type corresponding to the user, thereby setting the delay parameter matched to the user, improving the flexibility and accuracy of setting the delay parameter, and improving the user experience.

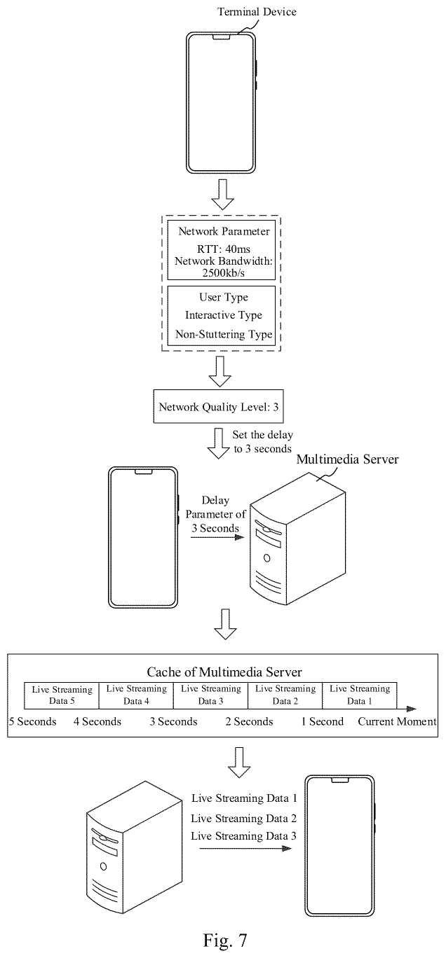

On the basis of any one of the above embodiments, the above-mentioned process of determining the live streaming delay will be described below with reference to FIG. 7.

FIG. 7 is a schematic diagram of a determination process of a live streaming delay provided by the embodiments of the present disclosure. Please refer to FIG. 7, a terminal device and a multimedia server are included. The network parameters of the terminal device include RTT and network bandwidth, where the RTT is 40 ms and the network bandwidth is 2500 kb/s. The user type corresponding to the user to which the live streaming client in the terminal device logs in includes the interactive type and the non-stuttering type.

Please refer to FIG. 7, because the RTT is 40 ms and the network bandwidth is 2500 kb/s, the terminal device may determine that the current network quality level is level 3, and because the user type corresponding to the user watching the live stream includes the interactive type, the terminal device may set the live streaming delay to 3 seconds.

Please refer to FIG. 7, the terminal device may send the delay parameter of 3 seconds to the multimedia server, and the cache of the multimedia server includes the live streaming data 1 from the current moment to the previous 1 second, the live streaming data 2 from the previous 1 second to the previous 2 seconds, the live streaming data 3 from the previous 2 seconds to the previous 3 seconds, the live streaming data 4 from the previous 3 seconds to the previous 4 seconds, and the live streaming data 5 from the previous 4 seconds to the previous 5 seconds.

Please refer to FIG. 7, after receiving the delay parameter of 3 seconds, the multimedia server may send the live streaming data 1, the live streaming data 2 and the live streaming data 3 to the terminal device, and after the terminal device receives the above-mentioned live streaming data, the live streaming video may be played based on the live streaming data. Thus, because the terminal device can flexibly determine the delay parameter when watching the live stream based on the user type and the network parameters, and the terminal device can set the matched delay parameter for the user in conjunction with the user's habit of watching the live stream, thereby improving the flexibility of setting the delay parameter of the live stream, and improving the user experience, and the low delay can effectively save the network bandwidth for the user whose network is better.

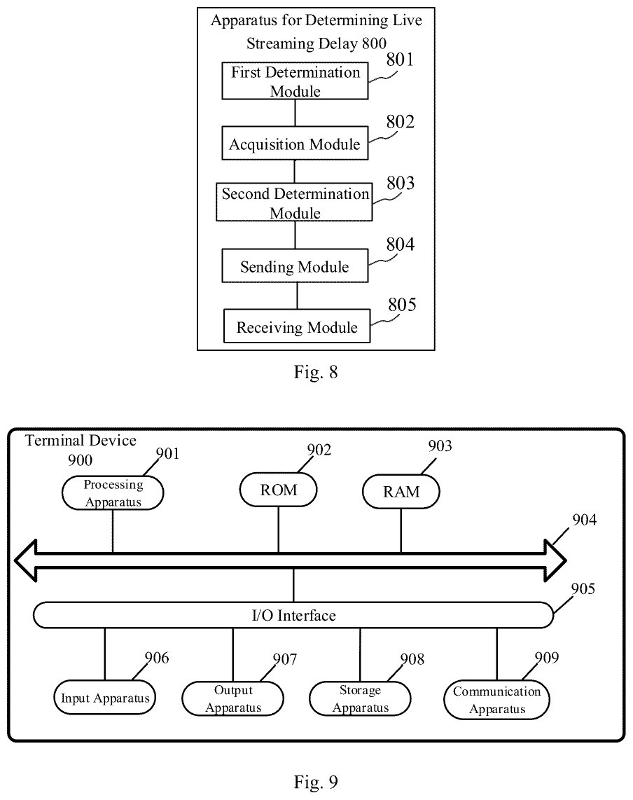

FIG. 8 is a schematic structural diagram of an apparatus for determining a live streaming delay provided by the embodiments of the present disclosure. Please refer to FIG. 8, the apparatus 800 for determining a live streaming delay includes a first determination module 801, an acquisition module 802, a second determination module 803, a sending module 804 and a receiving module 805.

The first determination module 801 is configured to determine a user type corresponding to a user watching a live stream.

The acquisition module 802 is configured to acquire a network parameter for the user when watching the live stream.

The second determination module 803 is configured to determine, based on the user type and the network parameter, a delay parameter for the user when watching the live stream, in which the delay parameter is associated with a delay of the user watching the live stream.

The sending module 804 is configured to send the delay parameter to a multimedia server.

The receiving module 805 is configured to receive live streaming data sent by the multimedia server based on the delay parameter.

According to one or more embodiments of the present disclosure, the second determination module 803 is configured to:
determine, based on the network parameter, a network quality level for the user when watching the live stream; and
determine, based on the network quality level and the user type, the delay parameter for the user when watching the live stream.

According to one or more embodiments of the present disclosure, the second determination module 803 is configured to:
in response to the network quality level being greater than or equal to the first threshold, and the user type including a non-stuttering type, set the delay parameter to a first preset value; and
in response to the network parameter being less than the first threshold, or the user type including a stuttering type, determine, based on the user type, the delay parameter for the user when watching the live stream.

According to one or more embodiments of the present disclosure, the second determination module 803 is configured to:
in response to the user type further including an interactive type, set the delay parameter to a second preset value; and
in response to the user type further including a non-interactive type, set the delay parameter to a third preset value;
the first preset value is less than the second preset value, and the second preset value is less than the third preset value.

According to one or more embodiments of the present disclosure, the first determination module 801 is configured to:
acquire a total number of stuttering times and live streaming interaction information of the user watching the live stream during a historical period;
determine the user type as a stuttering type or a non-stuttering type based on the total number of stuttering times; and
determine the user type as an interactive type or a non-interactive type based on the live streaming interaction information.

According to one or more embodiments of the present disclosure, the first determination module 801 is configured to:
in response to the total number of stuttering times being greater than or equal to a second threshold, determine the user type as the stuttering type; and
in response to the total number of stuttering times being less than the second threshold, determine the user type as the non-stuttering type.

According to one or more embodiments of the present disclosure, the first determination module 801 is configured to:
determine, based on the live streaming interaction information, an interaction frequency of the user when watching the live stream;
in response to the interaction frequency being greater than or equal to a third threshold, determine the user type as the interactive type; and
in response to the interaction frequency being less than the third threshold, determine the user type as the non-interactive type.

The apparatus for determining the live streaming delay provided by the embodiments of the present disclosure can be used to perform the technical solutions of the above-mentioned method embodiments, with similar implementation principles and technical effects. Detailed descriptions of these aspects are omitted in the present embodiment.

FIG. 9 is a schematic structural diagram of a terminal device provided by the embodiments of the present disclosure. Please refer to FIG. 9, which illustrates a schematic structural diagram of a terminal device 900 suitable for implementing the embodiments of the present disclosure. The terminal device may include, but is not limited to, mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), or the like, and fixed terminals such as a digital TV, a desktop computer, or the like. The terminal device illustrated in FIG. 9 is merely an example, and should not pose any limitation to the functions and the range of use of the embodiments of the present disclosure.

As illustrated in FIG. 9, the terminal device 900 may include a processing apparatus 901 (e.g., a central processing unit, a graphics processing unit, etc.), which can perform various suitable actions and processing according to a program stored in a read-only memory (ROM) 902 or a program loaded from a storage apparatus 908 into a random-access memory (RAM) 903. The RAM 903 further stores various programs and data required for operations of the terminal device 900. The processing apparatus 901, the ROM 902, and the RAM 903 are interconnected through a bus 904. An input/output (I/O) interface 905 is also connected to the bus 904.

Usually, the following apparatuses may be connected to the I/O interface 905: an input apparatus 906 including, for example, a touch screen, a touch pad, a keyboard, a mouse, a camera, a microphone, an accelerometer, a gyroscope, or the like; an output apparatus 907 including, for example, a liquid crystal display (LCD), a loudspeaker, a vibrator, or the like; a storage apparatus 908 including, for example, a magnetic tape, a hard disk, or the like; and a communication apparatus 909. The communication apparatus 909 may allow the terminal device 900 to be in wireless or wired communication with other devices to exchange data. While FIG. 9 illustrates the terminal device 900 having various apparatuses, it should be understood that not all of the illustrated apparatuses are necessarily implemented or included. More or fewer apparatuses may be implemented or included alternatively.

Particularly, according to the embodiments of the present disclosure, the processes described above with reference to the flowcharts may be implemented as a computer software program. For example, the embodiments of the present disclosure include a computer program product, which includes a computer program carried by a non-transitory computer-readable medium. The computer program includes program code for performing the methods shown in the flowcharts. In such embodiments, the computer program may be downloaded online through the communication apparatus 909 and installed, or may be installed from the storage apparatus 908, or may be installed from the ROM 902. When the computer program is executed by the processing apparatus 901, the above-mentioned functions defined in the methods of some embodiments of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program code. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

The above-mentioned computer-readable medium may be included in the above-mentioned terminal device, or may also exist alone without being assembled into the terminal device.

The above-mentioned computer-readable medium carries one or more programs, and when the one or more programs are executed by the terminal device, the terminal device is caused to perform the methods illustrated in the above-mentioned embodiments.

The embodiments of the present disclosure further provide a non-transitory computer-readable storage medium storing computer-executable instructions, which, when executed by a processor, implement the method as may be involved in the various possible embodiments described above.

The embodiments of the present disclosure further provide a computer program product, including a computer program, which, when executed by a processor, implements the method as may be involved in the various possible embodiments described above.

The computer program code for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the drawings illustrate the architecture, function, and operation of possible implementations of systems, methods, and computer program products according to various embodiments of the present disclosure. In this regard, each block in the flowcharts or block diagrams may represent a module, a program segment, or a portion of code, including one or more executable instructions for implementing specified logical functions. It should also be noted that, in some alternative implementations, the functions noted in the blocks may also occur out of the order noted in the drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances. For example, the first acquisition unit may also be described as a “unit for acquiring at least two Internet Protocol addresses.”

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

It should be noted that the modifications of “a,” “an,” “a plurality of,” or the like mentioned in the present disclosure are illustrative rather than restrictive, and those skilled in the art should understand that unless the context clearly indicates otherwise, these modifications should be understood as “one or more.”

The names of the messages or information exchanged between a plurality of apparatuses in the embodiments of the present disclosure are for illustrative purposes only and are not intended to limit the scope of these messages or information.

It may be understood that before using the technical solutions disclosed in the embodiments of the present disclosure, it is necessary to inform user(s) the types, using scope, and using scenarios of personal information involved in the present disclosure according to relevant laws and regulations in an appropriate manner and obtain the authorization of the user(s).

For example, in response to receiving a user's active request, a prompt message is sent to the user to clearly remind the user that the requested operation will require acquiring and using the user's personal information. Thus, users can selectively choose whether to provide personal information to the software or hardware such as an electronic device, an application, a server, or a storage medium that perform the operations of the technical solutions of the present disclosure according to the prompt message. As an optional but non-restrictive implementation, in response to receiving the user's active request, sending the prompt message to the user may be done in the form of a pop-up window, where the prompt message may be presented in text. In addition, the pop-up window may further carry a selection control for users to choose between “agree” or “disagree” to provide the personal information to an electronic device.

It may be understood that the above-mentioned processes of informing and acquiring user authorization are only illustrative and do not limit the embodiments of the present disclosure. Other methods that comply with relevant laws and regulations may also be applied to the embodiments of the present disclosure.

Meanwhile, it may be understood that the data involved in the technical solutions (including but not limited to the data itself, data acquisition or use) should comply with the requirements of corresponding laws, regulations and relevant provisions. The data may include information, parameters, messages, and the like, such as cut flow indication information.

The above descriptions are merely preferred embodiments of the present disclosure and illustrations of the technical principles employed. Those skilled in the art should understand that the scope of disclosure involved in the present disclosure is not limited to the technical solutions formed by the specific combination of the above-mentioned technical features, and should also cover, without departing from the above-mentioned disclosed concept, other technical solutions formed by any combination of the above-mentioned technical features or their equivalents, such as technical solutions which are formed by replacing the above-mentioned technical features with the technical features disclosed in the present disclosure (but not limited to) with similar functions.

Additionally, although operations are depicted in a particular order, it should not be understood that these operations are required to be performed in a specific order as illustrated or in a sequential order. Under certain circumstances, multitasking and parallel processing may be advantageous. Likewise, although the above discussion includes several specific implementation details, these should not be interpreted as limitations on the scope of the present disclosure. Certain features that are described in the context of separate embodiments may also be implemented in combination in a single embodiment. Conversely, various features that are described in the context of a single embodiment may also be implemented in multiple embodiments separately or in any suitable sub-combinations.

Although the subject matter has been described in language specific to structural features and/or method logical actions, it should be understood that the subject matter defined in the appended claims is not necessarily limited to the specific features or actions described above. Rather, the specific features and actions described above are merely example forms of implementing the claims.

1. A method for determining a live streaming delay, comprising:
determining a user type corresponding to a user watching a live stream;
acquiring a network parameter for the user when watching the live stream;
determining, based on the user type and the network parameter, a delay parameter for the user when watching the live stream, wherein the delay parameter is associated with a delay of the user watching the live stream; and
sending the delay parameter to a multimedia server, and receiving live streaming data sent by the multimedia server based on the delay parameter.

2. The method according to claim 1, wherein the determining, based on the user type and the network parameter, the delay parameter for the user when watching the live stream, comprises:
determining, based on the network parameter, a network quality level for the user when watching the live stream; and
determining, based on the network quality level and the user type, the delay parameter for the user when watching the live stream.

3. The method according to claim 2, wherein the determining, based on the network quality level and the user type, the delay parameter for the user when watching the live stream, comprises:
in response to the network quality level being greater than or equal to the first threshold, and the user type comprising a non-stuttering type, setting the delay parameter to a first preset value; and
in response to the network parameter being less than the first threshold, or the user type comprising a stuttering type, determining, based on the user type, the delay parameter for the user when watching the live stream.

4. The method according to claim 3, wherein the determining, based on the user type, the delay parameter for the user when watching the live stream, comprises:
in response to the user type further comprising an interactive type, setting the delay parameter to a second preset value; and
in response to the user type further comprising a non-interactive type, setting the delay parameter to a third preset value,
wherein the first preset value is less than the second preset value, and the second preset value is less than the third preset value.

5. The method according to claim 1, wherein determining the user type corresponding to the user watching the live stream comprises:
acquiring a total number of stuttering times and live streaming interaction information of the user watching the live stream during a historical period;
determining the user type as a stuttering type or a non-stuttering type based on the total number of stuttering times; and
determining the user type as an interactive type or a non-interactive type based on the live streaming interaction information.

6. The method according to claim 2, wherein determining the user type corresponding to the user watching the live stream comprises:
acquiring a total number of stuttering times and live streaming interaction information of the user watching the live stream during a historical period;
determining the user type as a stuttering type or a non-stuttering type based on the total number of stuttering times; and
determining the user type as an interactive type or a non-interactive type based on the live streaming interaction information.

7. The method according to claim 3, wherein determining the user type corresponding to the user watching the live stream comprises:
acquiring a total number of stuttering times and live streaming interaction information of the user watching the live stream during a historical period;
determining the user type as a stuttering type or a non-stuttering type based on the total number of stuttering times; and
determining the user type as an interactive type or a non-interactive type based on the live streaming interaction information.

8. The method according to claim 4, wherein determining the user type corresponding to the user watching the live stream comprises:
acquiring a total number of stuttering times and live streaming interaction information of the user watching the live stream during a historical period;
determining the user type as a stuttering type or a non-stuttering type based on the total number of stuttering times; and
determining the user type as an interactive type or a non-interactive type based on the live streaming interaction information.

9. The method according to claim 5, wherein the determining the user type as the stuttering type or the non-stuttering type based on the total number of stuttering times, comprises:
in response to the total number of stuttering times being greater than or equal to a second threshold, determining the user type as the stuttering type; and
in response to the total number of stuttering times being less than the second threshold, determining the user type as the non-stuttering type.

10. The method according to claim 6, wherein the determining the user type as the stuttering type or the non-stuttering type based on the total number of stuttering times, comprises:
in response to the total number of stuttering times being greater than or equal to a second threshold, determining the user type as the stuttering type; and
in response to the total number of stuttering times being less than the second threshold, determining the user type as the non-stuttering type.

11. The method according to claim 7, wherein the determining the user type as the stuttering type or the non-stuttering type based on the total number of stuttering times, comprises:
in response to the total number of stuttering times being greater than or equal to a second threshold, determining the user type as the stuttering type; and
in response to the total number of stuttering times being less than the second threshold, determining the user type as the non-stuttering type.

12. The method according to claim 8, wherein the determining the user type as the stuttering type or the non-stuttering type based on the total number of stuttering times, comprises:
in response to the total number of stuttering times being greater than or equal to a second threshold, determining the user type as the stuttering type; and
in response to the total number of stuttering times being less than the second threshold, determining the user type as the non-stuttering type.

13. The method according to claim 5, wherein the determining the user type as the interactive type or the non-interactive type based on the live streaming interaction information, comprises:
determining, based on the live streaming interaction information, an interaction frequency of the user when watching the live stream;
in response to the interaction frequency being greater than or equal to a third threshold, determining the user type as the interactive type; and
in response to the interaction frequency being less than the third threshold, determining the user type as the non-interactive type.

14. The method according to claim 6, wherein the determining the user type as the interactive type or the non-interactive type based on the live streaming interaction information, comprises:
determining, based on the live streaming interaction information, an interaction frequency of the user when watching the live stream;
in response to the interaction frequency being greater than or equal to a third threshold, determining the user type as the interactive type; and
in response to the interaction frequency being less than the third threshold, determining the user type as the non-interactive type.

15. The method according to claim 7, wherein the determining the user type as the interactive type or the non-interactive type based on the live streaming interaction information, comprises:
determining, based on the live streaming interaction information, an interaction frequency of the user when watching the live stream;
in response to the interaction frequency being greater than or equal to a third threshold, determining the user type as the interactive type; and
in response to the interaction frequency being less than the third threshold, determining the user type as the non-interactive type.

16. The method according to claim 8, wherein the determining the user type as the interactive type or the non-interactive type based on the live streaming interaction information, comprises:
determining, based on the live streaming interaction information, an interaction frequency of the user when watching the live stream;
in response to the interaction frequency being greater than or equal to a third threshold, determining the user type as the interactive type; and
in response to the interaction frequency being less than the third threshold, determining the user type as the non-interactive type.

17. A terminal device, comprising a processor and a memory,
wherein the memory is configured to store computer-executable instructions; and
the processor is configured to execute the computer-executable instructions stored in the memory to implement a method for determining a live streaming delay, and the method for determining a live streaming delay comprises:
determining a user type corresponding to a user watching a live stream;
acquiring a network parameter for the user when watching the live stream;
determining, based on the user type and the network parameter, a delay parameter for the user when watching the live stream, wherein the delay parameter is associated with a delay of the user watching the live stream; and
sending the delay parameter to a multimedia server, and receiving live streaming data sent by the multimedia server based on the delay parameter.

18. The terminal device according to claim 17, wherein the determining, based on the user type and the network parameter, the delay parameter for the user when watching the live stream, comprises:
determining, based on the network parameter, a network quality level for the user when watching the live stream; and
determining, based on the network quality level and the user type, the delay parameter for the user when watching the live stream.

19. The terminal device according to claim 18, wherein the determining, based on the network quality level and the user type, the delay parameter for the user when watching the live stream, comprises:
in response to the network quality level being greater than or equal to the first threshold, and the user type comprising a non-stuttering type, setting the delay parameter to a first preset value; and
in response to the network parameter being less than the first threshold, or the user type comprising a stuttering type, determining, based on the user type, the delay parameter for the user when watching the live stream.

20. A non-transitory computer-readable storage medium, storing computer-executable instructions, wherein a processor, when executing the computer-executable instructions, implements a method for determining a live streaming delay, and the method for determining a live streaming delay comprises:
determining a user type corresponding to a user watching a live stream;
acquiring a network parameter for the user when watching the live stream;
determining, based on the user type and the network parameter, a delay parameter for the user when watching the live stream, wherein the delay parameter is associated with a delay of the user watching the live stream; and
sending the delay parameter to a multimedia server, and receiving live streaming data sent by the multimedia server based on the delay parameter.
